(19) United States
(12) Patent Application Publication
(10) Pub. No.: US 2015/0348483 A1
(43) Pub. Date: Dec. 3, 2015

(54) DRIVING METHOD OF LIQUID DISPLAY PANEL

(71) Applicant: Shenzhen China Star Optoelectronics Technology Co. Ltd., Shenzhen, Guangdong (CN)

(72) Inventor: Peng DU, Shenzhen, Guangdong (CN)

(73) Assignee: Shenzhen China Star Optoelectronics Technology Co. Ltd., Shenzhen, Guangdong (CN)

(21) Appl. No.: 14/375,430

(22) PCT Filed: Jun. 12, 2014
(86) PCT No.: PCT/CN2014/079713

§ 371 Date: Jul. 29, 2014

(30) Foreign Application Priority Data
May 27, 2014 (CN) 201410228376.8

(51) Int. Cl. G09G 3/36

(52) U.S. Cl. CPC G09G 3/3648; G09G 3/3688; G09G 3/3614; G09G 3/3696; G09G 2330/021; G09G 2320/043

(57) ABSTRACT

The present invention provides a driving method of a liquid display panel, comprising: providing a plurality of data lines, a plurality of gate lines (Gate 1-Gate m), and a plurality of pixels (P), and each of the pixels is connected with one data line and one gate line, and the polarity of each of the pixels are opposite to the polarities of adjacent pixels at up, down, left and right; sequentially conducting the gate lines of the pixels which are first polarity corresponding to a driving voltage to complete signal writing of a half frame; sequentially conducting the gate lines of the pixels which are second polarity corresponding to a driving voltage to complete signal writing of the other half frame; the first polarity is opposite to the second polarity, and the m is a multiple of 4. By using the driving method of the liquid display panel, the signal of the data line merely switches the polarity of the driving voltage twice in a period of a frame. The power consumption of the whole panel is reduced. The charging conditions of the pixels are improved and the display quality is enhanced.

### FIELD OF THE INVENTION

The present invention relates to the field of liquid crystal display, and more particularly to a driving method of a liquid display panel.

### BACKGROUND OF THE INVENTION

TFT-LCD (Thin Film Transistor Liquid Crystal Display) possesses properties of small occupied space, low power consumption and no radiation. It dominates the major part of the current flat display panel's market. A TFT-LCD mainly comprises an array substrate and a color film substrate, which are cell assembled to sandwich the liquid crystals therebetween. Gate lines for supplying scan signals, data lines for supplying data signals, pixel electrodes and thin film transistors of forming pixels are formed on the array substrate. Each pixel electrode is controlled by the thin film transistor. When the thin film transistor is conducted, the pixel electrode is charged during the period of conducting time. After the thin film transistor is off, the voltage of the pixel electrode is maintained until the next scan to be recharged. A black matrix and a color resin are formed on the color film substrate.

As the liquid crystal display is showing images, polarity inversion mode is utilized to prevent the aging of the liquid crystals. Typical inversion modes can be: frame inversion, line inversion, column inversion and dot inversion. The definition of the polarity in the polarity inversion mode is that it is positive polarity when the pixel voltage signal is higher than the common electrode signal and it is negative polarity when the pixel voltage signal is lower than the common electrode signal.

At present, in the manufacture process of a liquid crystal display panel, the manufacture cost reduction is a major topic which is significantly important. A present HSD (Half Source Driving) structure is to double the amount of the gate lines for supplying the scan signals and reduce the amount of data lines for supplying data signals by half. In comparison with a traditional structure, the total amount of the signal lines is obviously decreased. Accordingly, the number of the source driving IC is cut down to realize the objective of reducing the manufacture cost.

In all present driving methods for the liquid crystal display panels, the dot inversion is the inversion mode with the best display effect. Please refer to FIG. 1, which is a circuit structure diagram of a TFT-LCD panel employing HSD structure and dot inversion according to prior art. It comprises a plurality of data lines (Data1-Data5) of supplying data signals, a plurality of gate lines (Gate1-Gate8) of supplying scan signal which are crossing with the data lines, and a plurality of pixels (P); each of the pixels (P) is connected with one data line and one gate line, and the polarity of each of the pixels are opposite to the polarities of adjacent pixels at up, down, left and right;

The pixel (P) comprises a thin film transistor (Tr) and a pixel electrode (D); the thin film transistor (Tr) has a gate (g), a source (s) and a drain (d); the pixel electrode (P) is electrically connected to the drain (d) of the thin film transistor (Tr); specifically, each pixel on the liquid crystal display can equivalent to a parallel connection structure of a liquid crystal capacitor (C_{LC}) and a storage capacitor (C_{stg}). One electrode of the liquid crystal capacitor (C_{LC}) and one electrode of the storage capacitor (C_{stg}) are connected to the pixel electrode (D). The other electrodes are connected to a common electrode lines (VCOM).

The gates (g) of the thin film transistors (Tr) in the pixels (P) arranged in the same odd row are commonly connected to one of 2n+2^{th} (n=0, 1, 2 . . . ) gate lines (Gate2, Gate4, Gate6, Gate8); the gates (g) of the thin film transistors (Tr) in the pixels (P) arranged in the same even row are commonly connected to one of 2n+1^{th} (n=0, 1, 2 . . . ) gate lines (Gate1, Gate3, Gate5, Gate7); the sources (s) of the thin film transistors (Tr) in the pixels (P) arranged in the same row are commonly connected to one of data lines and the sources (s) of the thin film transistors (Tr) in the pixels (P) arranged in 2n+2^{th} row and 2n+2^{th} row are all electrically connected to corresponding n+2^{th} (n=0, 1, 2 . . . ) data lines.

The thin film transistors (Tr) can charge the pixels (D) at different times.

Please refer to FIG. 2, which is a sequence diagram as traditional driving method is utilized in FIG. 1, the HD (High Definition) resolution is taken as an example. The gate lines are conducted according to a sequence of 1, 2, 3 . . . n, n+1. The data lines are required to be switched the polarity once in the period that every two gate lines are conducted. The second data line (Data2) is illustrated. The driving voltage of the second data line (Data2) is negative polarity (−) as the first gate line (Gate1) is conducted. The driving voltage of the second data line (Data2) is positive polarity (+) as the second gate line (Gate2) and the third gate line (Gate3) are conducted. The driving voltage of the second data line (Data2) needs to be switched to be negative polarity (−) as the fourth gate line (Gate4) and the fifth gate line (Gate5) are conducted. The driving voltage of the second data line (Data2) is negative polarity (−) as the 4n+2^{th} gate line and the 4n+3^{th} gate line are conducted (n=0, 1, 2 . . . ). The driving voltage of the second data line (Data2) is positive polarity (+) as the 4n^{th} gate line and the 4n+1^{th} gate line are conducted (n=0, 1, 2 . . . ). When every two pixels are charged, the signal of the second data line (Data2) needs to switch the polarity of the driving voltage once.

Thus, under circumstance that that traditional driving method is utilized to the liquid display panel employing the HSD structure. In case that the resolution is HD and the working frequency is 60 Hz, the signal of the data line needs to switch the polarity of the driving voltage once for every two pixels when the liquid crystal panel is functioned. That is, the polarity needs to be switched once about every 21.7 ps. In a period of the whole frame, the polarity needs to be switched for 768 times. The corresponding signal frequency is 768×60=46.08 kHz. Here come the drawbacks, the signal frequency is too high and the power consumption of the data lines is increased on one hand. On the other hand, the pixel charging time in the HSD structure is very short, and the RC delay effect of the signal switching on the data lines may further influence the pixel charging condition. It counts against the improvement of the display quality. When the resolution of the liquid crystal display is raised, such issues become serious even more.

### SUMMARY OF THE INVENTION

An objective of the present invention is to provide a driving method of a liquid display panel. On the basis of achieving dot inversion, the frequency of the positive/negative polarity switching of the signals on the data lines is enormously reduced. Accordingly, the power consumption of HSD structure panel is reduced. The charging conditions of the pixels are efficiently improved and the display quality is enhanced.

For achieving the aforesaid objective, the present invention provides a driving method of a liquid display panel, comprising:
step 100, providing a plurality of data lines, a plurality of gate lines (Gate 1-Gate m), and a plurality of pixels (P), and each of the pixels is connected with one data line and one gate line, and the polarity of each of the pixels are opposite to the polarities of adjacent pixels at up, down, left and right;
step 200, sequentially conducting the gate lines of the pixels which are first polarity corresponding to a driving voltage to complete signal writing of a half frame;
step 300, sequentially conducting the gate lines of the pixels which are second polarity corresponding to a driving voltage to complete signal writing of the other half frame;
the first polarity is opposite to the second polarity.

The signal of the data line switches the polarity of the driving voltage twice in a period of a frame, and the first polarity is negative polarity and the second polarity is positive polarity.

The m is a multiple of 4.

A sequence of conducting the gate lines in the step 200 is on the basis of gate line number from small to big.

A sequence of conducting the gate lines in the step 300 is on the basis of gate line number from small to big.

A sequence of conducting the gate lines in the step 300 is on the basis of gate line number from big to small.

The m is 1536, and the gate lines are conducted according to a sequence of 1→4→5→ . . . →4n→1→ . . . →1533→1536→2→3→ . . . 4n+2→4n+3→ . . . →1534→1535 to complete the signal writing of a whole frame, and the driving voltages of the corresponding data signals are first polarity during the period when the 1^{th} gate line to the 1536^{th} gate line (Gate1→Gate1536) are conducted, and the driving voltages of the corresponding data signals are second polarity during the period when the 2^{th} gate line to the 1535^{th} gate line (Gate2→Gate1535) are conducted.

The m is 1536, and the gate lines are conducted according to a sequence of 1→4→5→ . . . →4n→4n+1→ . . . →1533→1536→1535→1534→ . . . 4n+3→4n+2→ . . . 3→2 to complete the signal writing of a whole frame, and the driving voltages of the corresponding data signals are first polarity during the period when the 1^{th} gate line to the 1536^{th} gate line (Gate1→Gate1536) are conducted, and the driving voltages of the corresponding data signals are second polarity during the period when the 1535^{th} gate line to the 2^{th} gate line (Gate1535→Gate2) are conducted.

The pixel (P) comprises a thin film transistor (Tr) and a pixel electrode (D); the thin film transistor (Tr) has a gate (g), a source (s) and a drain (d); the pixel electrode (P) is electrically connected to the drain (d) of the thin film transistor (Tr); the gates (g) of the thin film transistors (Tr) in the pixels (P) arranged in the same odd row are commonly connected to one of 2n+2^{th} gate lines; the gates (g) of the thin film transistors (Tr) in the pixels (P) arranged in the same even row are commonly connected to one of 2n+1^{th} gate lines; the sources (s) of the thin film transistors (Tr) in the pixels (P) arranged in the same row are commonly connected to one of data lines and the sources (s) of the thin film transistors (Tr) in the pixels (P) arranged in 2n+2^{th} row and 2n+2^{th} row are all electrically connected to corresponding n+2^{th} data lines.

A HSD structure is employed in the liquid display panel.

The present invention also provides a driving method of a liquid display panel, comprising:
step 100, providing a plurality of data lines, a plurality of gate lines (Gate 1-Gate m), and a plurality of pixels (P), and each of the pixels is connected with one data line and one gate line, and the polarity of each of the pixels are opposite to the polarities of adjacent pixels at up, down, left and right;
step 200, sequentially conducting the gate lines of the pixels which are first polarity corresponding to a driving voltage to complete signal writing of a half frame;
step 300, sequentially conducting the gate lines of the pixels which are second polarity corresponding to a driving voltage to complete signal writing of the other half frame;
the first polarity is opposite to the second polarity;
wherein the m is a multiple of 4;
wherein a sequence of conducting the gate lines in the step 200 is on the basis of gate line number from small to big;
wherein a sequence of conducting the gate lines in the step 300 is on the basis of gate line number from small to big;
wherein the m is 1536, and the gate lines are conducted according to a sequence of 1→4→5→ . . . 4n→4n+1→ . . . →1533→1536→2→3→ 4n+2→4n+3→ . . . →1534→1535 to complete the signal writing of a whole frame, and the driving voltages of the corresponding data signals are first polarity during the period when the 1^{th} gate line to the 1536^{th} gate line (Gate1→Gate1536) are conducted, and the driving voltages of the corresponding data signals are second polarity during the period when the 2^{th} gate line to the 1535^{th} gate line (Gate2→Gate1535) are conducted;
wherein the pixel (P) comprises a thin film transistor (Tr) and a pixel electrode (D); the thin film transistor (Tr) has a gate (g), a source (s) and a drain (d); the pixel electrode (P) is electrically connected to the drain (d) of the thin film transistor (Tr); the gates (g) of the thin film transistors (Tr) in the pixels (P) arranged in the same odd row are commonly connected to one of 2n+2^{th} gate lines; the gates (g) of the thin film transistors (Tr) in the pixels (P) arranged in the same even row are commonly connected to one of 2n+1^{th} gate lines; the sources (s) of the thin film transistors (Tr) in the pixels (P) arranged in the same row are commonly connected to one of data lines and the sources (s) of the thin film transistors (Tr) in the pixels (P) arranged in 2n+2^{th} row and 2n+2^{th} row are all electrically connected to corresponding n+2^{th} data lines;
wherein a HSD structure is employed in the liquid display panel.

The benefit of the present invention is: a driving method of a liquid display panel is provided. The driving method of a HSD structure liquid display panel is re-designed on the basis of dot inversion. By sequentially conducting the gate lines of the pixels which are first polarity corresponding to a driving voltage on the basis of gate line number from small to big to complete signal writing of a half frame; sequentially conducting the gate lines of the pixels which are second polarity corresponding to a driving voltage on the basis of gate line number from small to big, or sequentially conducting the gate lines of the pixels which are second polarity corresponding to a driving voltage on the basis of gate line number from big to small to complete signal writing of the other half frame, and the first polarity is opposite to the second polarity. Accordingly, the signal of the data line merely switches the polarity of the driving voltage twice in a period of a frame and the frequency of the positive/negative polarity switching of the signals on the data lines the frequency of the positive/negative polarity switching of the signals on the data lines. Consequently, the power consumption of HSD structure panel is reduced and the charging conditions of the pixels are efficiently improved and the display quality is enhanced.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution, as well as beneficial advantages, of the present invention will be apparent from the following detailed description of an embodiment of the present invention, with reference to the attached drawings.

In the attached drawings,

FIG. 1 is a circuit structure diagram of a TFT-LCD panel employing HSD structure and dot inversion according to prior art;

FIG. 2 is a sequence diagram as traditional driving method is utilized in FIG. 1;

FIG. 3 is a flowchart of a driving method of a liquid display panel according to the present invention;

FIG. 4 is a sequence diagram of the first embodiment of employing the driving method of the present invention in FIG. 1;

FIG. 5 is a sequence diagram of the second embodiment of employing the driving method of the present invention in FIG. 1.

### DETAILED DESCRIPTION OF PREFERRED EMBODIMENTS

Embodiments of the present invention are described in detail with the technical matters, structural features, achieved objects, and effects with reference to the accompanying drawings as follows.

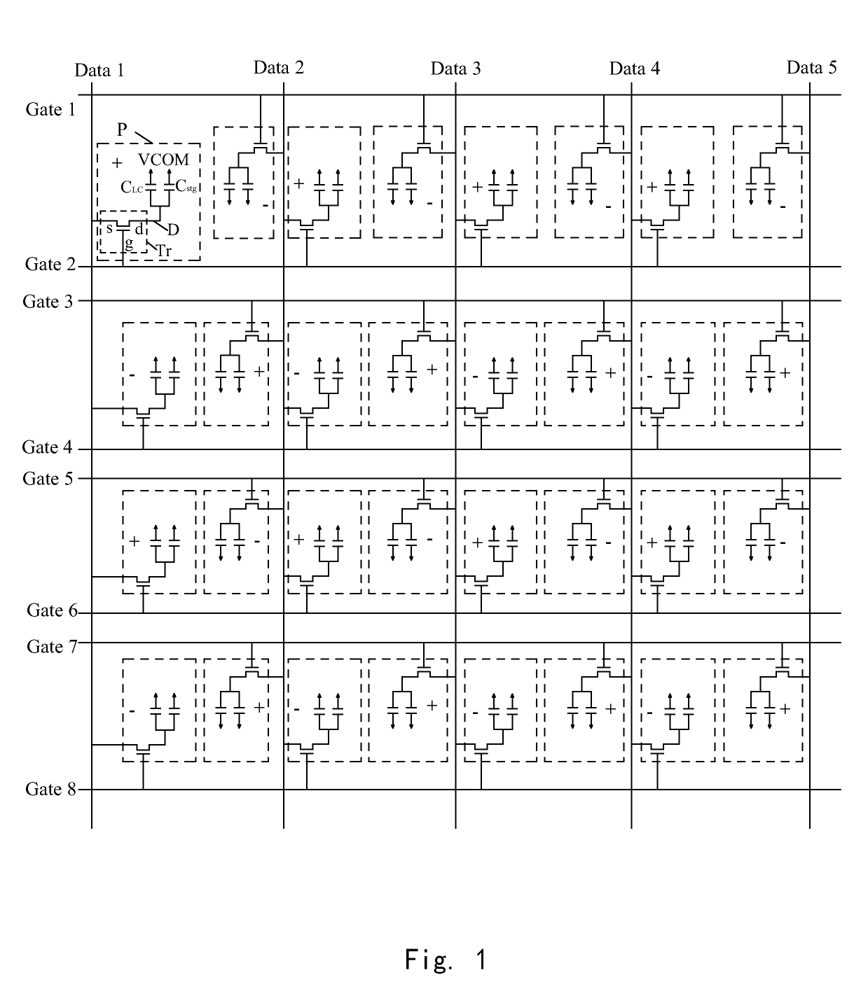

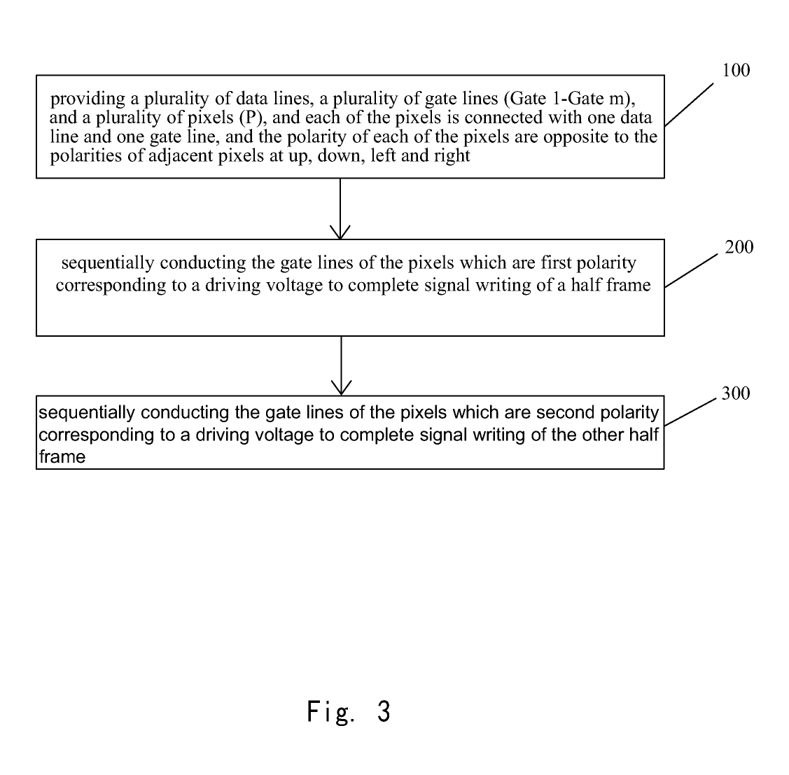

Please refer to FIG. 3 in conjunction with FIG. 1. The present invention provides a driving method of a liquid display panel, comprising:
step 100, providing a plurality of data lines, a plurality of gate lines (Gate 1-Gate m), and a plurality of pixels (P), and each of the pixels is connected with one data line and one gate line, and the polarity of each of the pixels are opposite to the polarities of adjacent pixels at up, down, left and right;
step 200, sequentially conducting the gate lines of the pixels which are first polarity corresponding to a driving voltage to complete signal writing of a half frame;
step 300, sequentially conducting the gate lines of the pixels which are second polarity corresponding to a driving voltage to complete signal writing of the other half frame;
the first polarity is opposite to the second polarity.

The signal of the data line switches the polarity of the driving voltage twice in a period of a frame.

The m is a multiple of 4.

The pixel (P) comprises a thin film transistor (Tr) and a pixel electrode (D); the thin film transistor (Tr) has a gate (g), a source (s) and a drain (d); the pixel electrode (P) is electrically connected to the drain (d) of the thin film transistor (Tr); the gates (g) of the thin film transistors (Tr) in the pixels (P) arranged in the same odd row are commonly connected to one of 2n+2^{th} gate lines; the gates (g) of the thin film transistors (Tr) in the pixels (P) arranged in the same even row are commonly connected to one of 2n+1^{th} gate lines; the sources (s) of the thin film transistors (Tr) in the pixels (P) arranged in the same row are commonly connected to one of data lines and the sources (s) of the thin film transistors (Tr) in the pixels (P) arranged in 2n+2^{th} row and 2n+2^{th} row are all electrically connected to corresponding n+2^{th} data lines.

A HSD structure is employed in the liquid display panel.

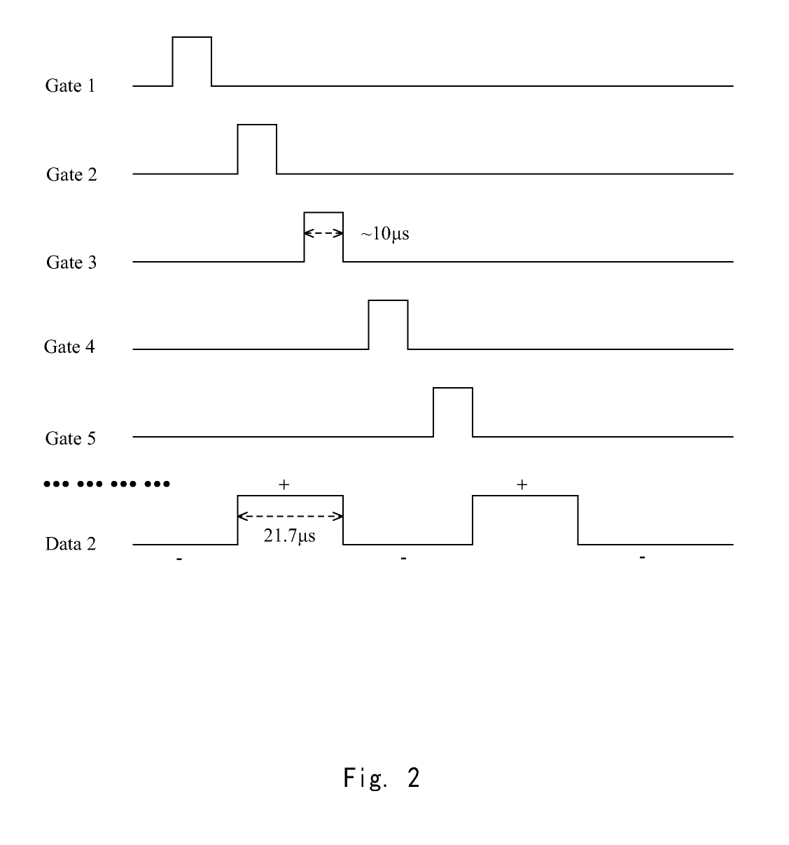

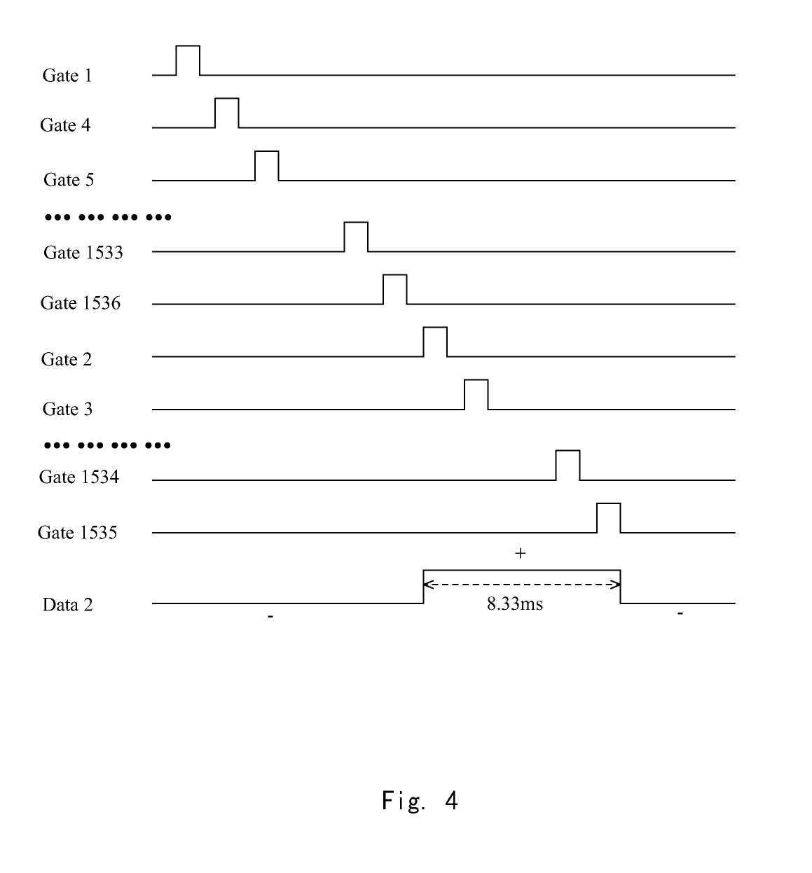

Please refer to FIG. 4 in conjunction with FIG. 1 and FIG. 3. FIG. 4 is a sequence diagram of the first embodiment of employing the driving method of the present invention in FIG. 1. In scenario that m is 1536, and the first polarity is negative polarity (−) and the second polarity is positive polarity (+). Specifically, the second data line (Data2) shown in FIG. 1 (the resolution of the liquid crystal panel is HD, the resolution is 1366×768 and the working frequency is 60 Hz) is illustrated. The gate lines are conducted according to a sequence of 1→4→5→ . . . 4n→4n+1→ . . . →1533→1536→2→3→ . . . 4n+2→4n+3→ . . . →1534→153 5 to complete the signal writing of a whole frame. The driving voltages of the corresponding data signals are negative polarity (−) during the period when the 1^{th} gate line to the 1536^{th} gate line (Gate1→Gate1536) are conducted, and the driving voltages of the corresponding data signals are positive polarity (+) during the period when the 2^{th} gate line to the 1535^{th} gate line (Gate2→Gate1535) are conducted. In a period of a frame, the polarity merely needs to be switched twice. The second data line (Data2) switches the polarity of the signal every 8.33 ms. The frequency of the corresponding signal drops from 46.08 kHz when the traditional driving method is utilized (Please refer to FIG. 2) to 120 Hz, i.e. the corresponding signal drops to 1/384 when the traditional driving method is utilized. On the basis of realizing dot inversion, the frequency of the positive/negative polarity switching of the signals on the data lines is enormously reduced on one hand, the influence of the data line resistor-capacitor delay effect to the pixel charging can be minimized and the display quality is enhanced on the other hand.

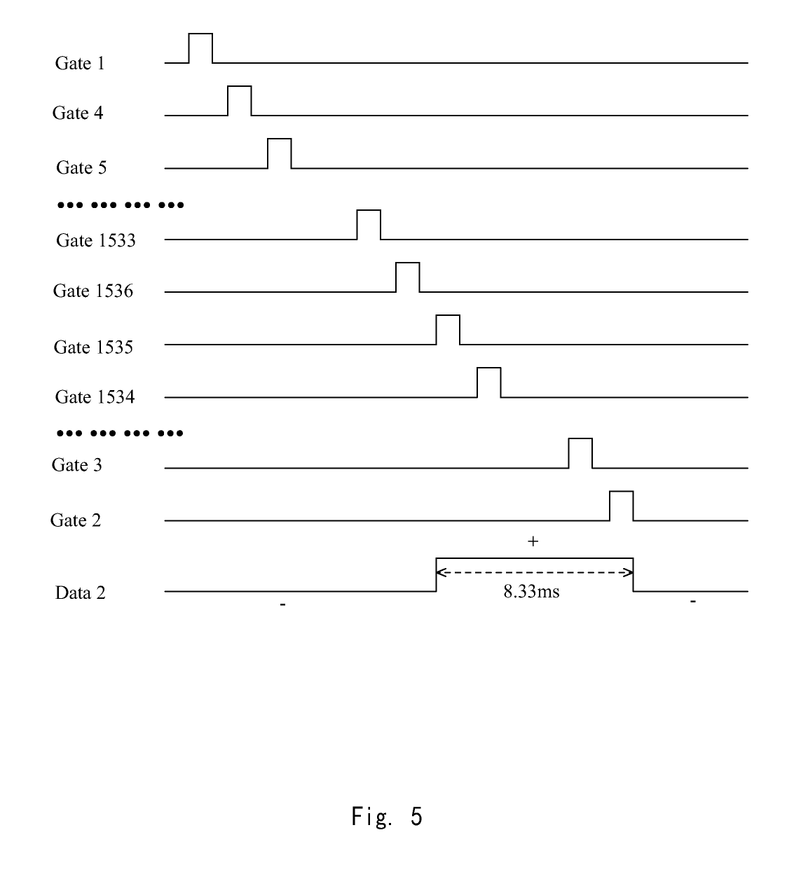

Please refer to FIG. 5 in conjunction with FIG. 1 and FIG. 3. FIG. 5 is a sequence diagram of the second embodiment of employing the driving method of the present invention in FIG. 1. Likewise, in scenario that m is 1536, and the first polarity is negative polarity (−) and the second polarity is positive polarity (+). Specifically, the second data line (Data2) shown in FIG. 1 (the resolution of the liquid crystal panel is HD, the resolution is 1366×768 and the working frequency is 60 Hz) is illustrated. The gate lines are conducted according to a sequence of 1→4→5→ . . . 4n→4n+1→ . . . →1533→1536→1535→1534→ . . . 4n+3→4n+2→ . . . →3→2 to complete the signal writing of a whole frame. The driving voltages of the corresponding data signals are negative polarity (−) during the period when the 1^{th} gate line to the 1536^{th} gate line (Gate1→Gate1536) are conducted, and the driving voltages of the corresponding data signals are positive polarity (+) during the period when the 1535^{th} gate line to the 2^{th} gate line (Gate1535→Gate2) are conducted. In a period of a frame, the polarity merely needs to be switched twice in the same manner.

Unlike the first embodiment of the present invention in which during the first ½ and the second ½ of each frame, the gate lines are conducted on the basis of the same gate line number sequence, i.e. the 1^{th} gate line to the 1536^{th} gate line (Gate1→Gate1536) and the 2^{th} gate line to the 1535^{th} gate line (Gate2→Gate1535). That is, a sequence of conducting the gate lines in the step 200 is on the basis of gate line number from small to big; a sequence of conducting the gate lines in the step 300 is on the basis of gate line number from small to big; in the second embodiment in which during the first ½ and the second ½ of each frame, the gate lines are conducted on the basis of the reversed gate line number sequence, i.e. the 1^{th} gate line to the 1536^{th} gate line (Gate1→Gate1536) and the 1535^{th} gate line to the 2^{th} gate line (Gate1535→Gate2). That is, a sequence of conducting the gate lines in the step 200 is on the basis of gate line number from small to big; a sequence of conducting the gate lines in the step 300 is on the basis of gate line number from big to small. However, both the first embodiment and the second embodiment of the present invention are capable of realizing the objective of reducing the power consumption.

In conclusion, the present invention provides a driving method of a liquid display panel. The driving method of a HSD structure liquid display panel is re-designed on the basis of dot inversion. By sequentially conducting the gate lines of the pixels which are first polarity corresponding to a driving voltage on the basis of gate line number from small to big to complete signal writing of a half frame; sequentially conducting the gate lines of the pixels which are second polarity corresponding to a driving voltage on the basis of gate line number from small to big, or sequentially conducting the gate lines of the pixels which are second polarity corresponding to a driving voltage on the basis of gate line number from big to small to complete signal writing of the other half frame, and the first polarity is opposite to the second polarity. Accordingly, the signal of the data line merely switches the polarity of the driving voltage twice in a period of a frame and the frequency of the positive/negative polarity switching of the signals on the data lines the frequency of the positive/negative polarity switching of the signals on the data lines. Consequently, the power consumption of HSD structure panel is reduced and the charging conditions of the pixels are efficiently improved and the display quality is enhanced.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A driving method of a liquid display panel, comprising:
step 100, providing a plurality of data lines of supplying data signals, a plurality of gate lines of supplying scan signal which are crossing with the data lines, and a plurality of pixels, and each of the pixels is connected with one data line and one gate line, and the polarity of each of the pixels are opposite to the polarities of adjacent pixels at up, down, left and right;
step 200, sequentially conducting the gate lines of the pixels which are first polarity corresponding to a driving voltage to complete signal writing of a half frame;
step 300, sequentially conducting the gate lines of the pixels which are second polarity corresponding to a driving voltage to complete signal writing of the other half frame;
the first polarity is opposite to the second polarity.

2. The driving method of the liquid display panel according to claim 1, wherein the signal of the data line switches the polarity of the driving voltage twice in a period of a frame, and the first polarity is negative polarity and the second polarity is positive polarity.

3. The driving method of the liquid display panel according to claim 1, wherein m is a multiple of 4.

4. The driving method of the liquid display panel according to claim 1, wherein a sequence of conducting the gate lines in the step 200 is on the basis of gate line number from small to big.

5. The driving method of the liquid display panel according to claim 1, wherein a sequence of conducting the gate lines in the step 300 is on the basis of gate line number from small to big.

6. The driving method of the liquid display panel according to claim 1, wherein a sequence of conducting the gate lines in the step 300 is on the basis of gate line number from big to small.

7. The driving method of the liquid display panel according to claim 3, wherein m is 1536, and the gate lines are conducted according to a sequence of 1→4→5→ . . . →4n→4n+1→ . . . →1533→1536→2→3→4n+2→4n+3→ . . . →1534→1535 to complete the signal writing of a whole frame, and the driving voltages of the corresponding data signals are first polarity during the period when the 1^{th} gate line to the 1536^{th} gate line are conducted, and the driving voltages of the corresponding data signals are second polarity during the period when the 2^{th} gate line to the 1535^{th} gate line are conducted.

8. The driving method of the liquid display panel according to claim 3, wherein m is 1536, and the gate lines are conducted according to a sequence of 1→4→5→ . . . →4n→4n+1→ . . . →1533→1536→1535→1534→ . . . 4n+3→4n+2→ . . . →3→2 to complete the signal writing of a whole frame, and the driving voltages of the corresponding data signals are first polarity during the period when the 1^{th} gate line to the 1536^{th} gate line are conducted, and the driving voltages of the corresponding data signals are second polarity during the period when the 1535^{th} gate line to the 2^{th} gate line are conducted.

9. The driving method of the liquid display panel according to claim 1, wherein the pixel comprises a thin film transistor and a pixel electrode; the thin film transistor has a gate, a source and a drain; the pixel electrode is electrically connected to the drain of the thin film transistor; the gates of the thin film transistors in the pixels arranged in the same odd row are commonly connected to one of 2n+2^{th} gate lines; the gates of the thin film transistors in the pixels arranged in the same even row are commonly connected to one of 2n+1^{th} gate lines; the sources of the thin film transistors in the pixels arranged in the same row are commonly connected to one of data lines and the sources of the thin film transistors in the pixels arranged in 2n+2^{th} row and 2n+2^{th} row are all electrically connected to corresponding n+2^{th} data lines.

10. The driving method of the liquid display panel according to claim 1, wherein a HSD structure is employed in the liquid display panel.

11. A driving method of a liquid display panel, comprising:
step 100, providing a plurality of data lines of supplying data signals, a plurality of gate lines of supplying scan signal which are crossing with the data lines, and a plurality of pixels, and each of the pixels is connected with one data line and one gate line, and the polarity of each of the pixels are opposite to the polarities of adjacent pixels at up, down, left and right;
step 200, sequentially conducting the gate lines of the pixels which are first polarity corresponding to a driving voltage to complete signal writing of a half frame;
step 300, sequentially conducting the gate lines of the pixels which are second polarity corresponding to a driving voltage to complete signal writing of the other half frame;
the first polarity is opposite to the second polarity;
wherein m is a multiple of 4;
wherein a sequence of conducting the gate lines in the step 200 is on the basis of gate line number from small to big;
wherein a sequence of conducting the gate lines in the step 300 is on the basis of gate line number from small to big;
wherein m is 1536, and the gate lines are conducted according to a sequence of 1→4→5→ . . . 4n→4n+1→ . . . →1533→1536→2→3→ . . . 4n+2→4n+3→ . . . →1534→1535 to complete the signal writing of a whole frame, and the driving voltages of the corresponding data signals are first polarity during the period when the 1^{th} gate line to the 1536^{th} gate line are conducted, and the driving voltages of the corresponding data signals are second polarity during the period when the 2^{th} gate line to the 1535^{th} gate line are conducted;
wherein the pixel comprises a thin film transistor and a pixel electrode; the thin film transistor has a gate, a source and a drain; the pixel electrode is electrically connected to the drain of the thin film transistor; the gates of the thin film transistors in the pixels arranged in the same odd row are commonly connected to one of 2n+2^{th} gate lines; the gates of the thin film transistors in the pixels arranged in the same even row are commonly connected to one of 2n+1^{th} gate lines; the sources of the thin film transistors in the pixels arranged in the same row are commonly connected to one of data lines and the sources of the thin film transistors in the pixels arranged in 2n+2^{th} row and 2n+2^{th} row are all electrically connected to corresponding n+2^{th} data lines;
wherein a HSD structure is employed in the liquid display panel.
